(19) United States
(12) Patent Application Publication
(10) Pub. No.: US 2006/0263468 A1
(43) Pub. Date: Nov. 23, 2006

(54) Device for opening and closing injection nozzles in an injection moulding tool

(76) Inventor: Erwin Schunke, Frankenberg (DE)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/408,341

(22) Filed: Apr. 20, 2006

(30) Foreign Application Priority Data
Apr. 22, 2005 (DE) 10 2005 018 982.2

(51) Int. Cl. B29C 45/00

(52) U.S. Cl. 425/564

(57) ABSTRACT

The invention relates to a device for opening and closing injection nozzles in an injection moulding tool, with a control gear for non-positive connection of a drive unit to a nozzle needle arrangement and one or more hot runner nozzles of the injection moulding tool. Here the drive unit is arranged outside the injection moulding tool and the control gear is designed as a push rod gear with a first drive push rod for non-positive connection to the drive unit, and at least one further driven push rod for non-positive connection to the nozzle needle arrangement. The shafts of the drive pushrod intersect each other and have at least one pair of sliding surfaces so that a parallax movement of the first push rod gives rise to a parallax movement of the further push rod.

### CROSS-REFERENCE TO RELATED APPLICATIONS

The present patent application claims priority from German Patent Application No. 10 2005 018 982.2, filed on Apr. 22, 2005.

### BACKGROUND OF THE INVENTION

The present invention relates to a device for opening and closing injection nozzles in an injection moulding tool with a control gear for the non-positive connection of a drive unit with a nozzle needle arrangement of one or more hot runner nozzles of the injection moulding tool.

However, devices of the type already mentioned are by no means used exclusively in the so-called hot runner technology, in which the moulding compound to be processed is injected in cycled fashion into a moulding cavity via heated runners, valves and nozzles. The nozzle needles guided in heated runners for forming injection nozzles are pressed sealed against a nozzle tip, or raised from a nozzle opening to release it, by means of the control gear. For this purpose a method is known for using a control gear formed from a hydraulic piston drive, wherein a double-acting piston is connected to the shaft of the nozzle needle and is loaded alternately with a working fluid. Control gears fluid operated in this manner are subjected to a temperature load because of their integration in the injection moulding tool, which load corresponds essentially to the temperature of the injection moulding tool. This gives rise to special requirements, particularly with regard to the sealing materials required for the piston drive.

### SUMMARY OF THE INVENTION

On the basis of this state of the art, the object of this invention is to propose a device whose function is not subject to loads due to the tool temperature.

This object is achieved by a device with the characteristics of the claim.

In the device according to the invention the drive unit is arranged outside the injection moulding tool and the control gear is designed as a push rod gear with a first drive push rod for non-positive connection to the drive unit, and at least one further driven push rod for non-positive connection to the nozzle needle device. The axes of the push rods are arranged to intersect each other and have at least one pair of sliding surfaces so that parallax movement of the first push rod gives rise to a parallax movement of the further push rod.

The design of the control gear as a push rod arrangement guarantees that no impairment of the function of the control gear or the drive mechanism need be feared at the temperatures normally prevailing on the injection moulding tool.

By combining the push rod arrangement with a drive unit arranged outside and on the side of the injection moulding tool, the free availability of the top of the injection moulding tool regularly used as a connection side for connection of the injection moulding feed is possible without any restriction.

With regard to the term “push rod” used above, it must be stated that this term must only be understood in its kinematic sense, and should not imply any limitation in terms of the dimensions of the object described as “push rod”. The term “push rod” must therefore also be understood to refer to an element with a predominant longitudinal extension, as an element with a very compact design.

It is demonstrated as particularly advantageous for the push rods to be designed as toothed racks, since during a relative movement of the toothed racks designed to engage with the pair of sliding surfaces, new tooth pairs are always engaging with each other, thus enabling the formation of “push rods” of extreme longitudinal extension, as well as the combination of a “push rod” of extreme longitudinal extension with an extremely compact push rod.

When the push rods are arranged in a guide element arrangement with guide recesses designed for sliding guidance of the push rods, both a design that is extremely simple and an extremely simple combination of the control gear with an injection moulding tool is possible by integration or additional mounting.

It is demonstrated as particularly advantageous for the guide element arrangement to be designed in a modular housing unit for connection to the injection moulding tool, since this makes possible a particularly simple combination of the control gear with an injection moulding tool of standard design.

This may be achieved, by example, in that the guide element arrangement is connected to the injection moulding tool with the intervening arrangement of hot runner distributor.

Alternatively it is also possible to design the guiding arrangement as part of a hot runner distributor, i.e. perhaps integrating it in a hot runner distributor.

If the nozzle needle arrangement is connected to the driven push rod by means of a positioning device, it is possible to move against defined end stops during operation of the control gear and to carry out fine adjustment of the nozzle needle arrangement by means of the positioning device.

A guide element arrangement that is both minimised in terms of the number of parts and optimised in terms of guiding accuracy is possible if the guide element arrangement has at least one guiding piece which serves both to receive the drive push rod and to receive the driven push rod.

A particularly compact design of the device is made possible if the guide element arrangement is understood to be in axial alignment of the drive push rod with the drive unit.

According to a further preferred design of the invention, the device has means for indicating the position of the first drive push rod, the further drive push rod and/or the nozzle needle arrangement. The position of each element may therefore be determined or indicated directly or indirectly, as can also, in particular, the open or closed position of the nozzle needle arrangement, so that the user can also see immediately whether the drive push rods and/or the nozzle needle arrangement are actually moving and are therefore functional.

According to a particularly preferred design, the means have an indicator which, in the region of its first end, is essentially rigidly connected to the first drive push rod, the further drive push rod and/or the nozzle needle arrangement, and interacts with its second end with a scale which is provided in the region of the outer wall of the device or is arranged inside the device so that it can be read off through a recess in the outer wall of the device.

In a design alternative to this, the means may have a measured value transducer, an incremental measured value transducer, for example, whose signal serves to activate an electrical or electronic indicating device, an LCD display or an LED device, for example, wherein an evaluation unit, a microprocessor, for example, may be inserted between the measured value transducer and the indicating device.

### BRIEF DESCRIPTION OF THE DRAWINGS

Preferred embodiments of the device are explained in greater detail in the following with reference to the drawing, in which

FIG. 1 shows a partial representation of an injection moulding tool in sectional representation;

FIG. 2 shows a plan view of the injection moulding tool shown in FIG. 1;

FIG. 3 shows a plan view of the injection moulding tool shown in FIG. 1, in sectional representation along the course of the line of intersection III-III in FIG. 1, with push rod axes running at right angles to each other;

FIG. 4 shows a control gear show push rod axes run at an angle α of less than 90° to each other;

FIG. 5 shows a control gear with double 90° angling between a first drive rod, a first driven rod and a second driven rod;

FIG. 6 shows an embodiment of the device with an arrangement of a guide element device of the control gear integrated in a hot runner distributor;

FIG. 7 shows a plan view of the device represented in FIG. 6;

FIG. 8 shows a sectional representation of the device shown in FIG. 6, according to the course of lines of intersection VIII-VIII in FIG. 6;

FIG. 9 shows a further embodiment of the device with an Arrangement of a guide element device of the control gear integrated in a hot runner distributor, with means for indicating the position of the drive push rod;

FIG. 10 shows a diagrammatic sectional representation of the device according to the course of lines of intersection X-X in FIG. 9;

FIG. 11 shows a plan view of the device shown in FIG. 9; and

FIG. 12 shows a detail E according to FIG. 10, in an enlarged representation.

### DETAILED DESCRIPTION OF THE INVENTION

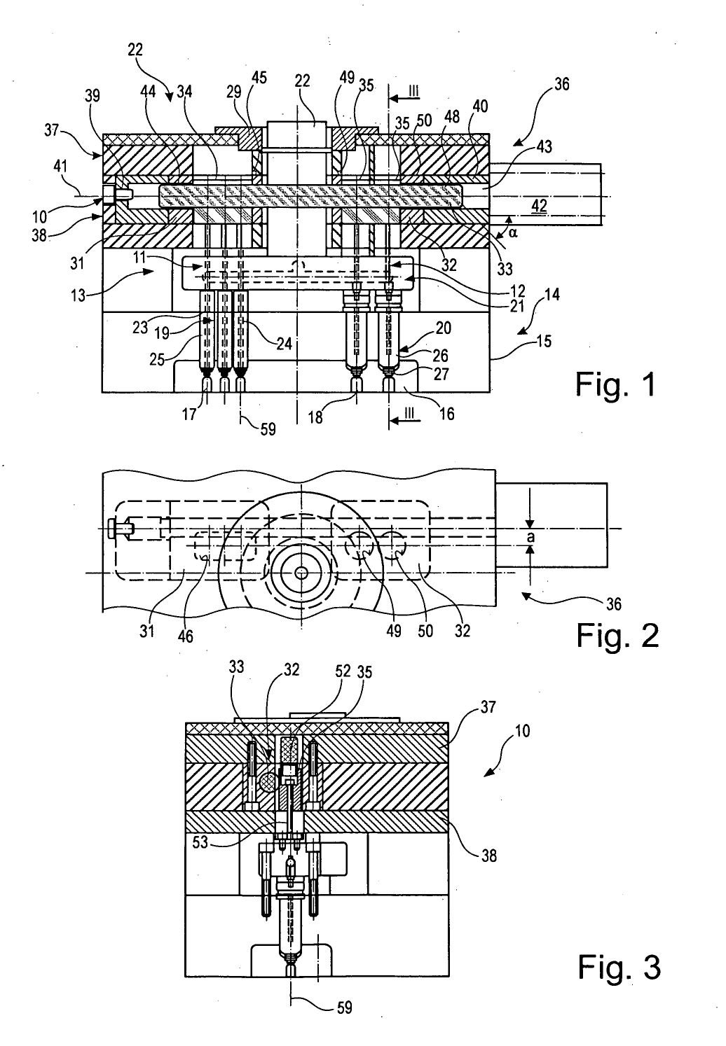

FIG. 1 shows a drive device 10 for driving a nozzle needle arrangement 13 comprising two nozzle needle groups 11, 12 in the case of this embodiment. Drive device 10 is formed on an injection moulding tool 14, which has a moulding tool (16) received in a moulding tool recess 15. In this case five moulding nests 17 and 18 are formed in moulding tool 16, which nests are connected to a source of injection moulding material not shown in greater detail here by associated hot runner nozzles 19 and 20 and a hot runner distributor 21 connected to it, which distributor is supplied with injection moulding material via an injection moulding material feed 22.

As is clearly shown in FIGS. 1, 2 and 3 together, drive device 10 comprises a guide element arrangement 30 with two guide pieces 31, 32, which are arranged together with a drive push rod 33 and three driven push rods 34, 35 in a drive module 36 designed in a general plate shape. Guide pieces 31, 32 and a receiving piece 39 are received in drive module 36 between two cover plates 37 and 38 in a drive module plate 40, which receiving piece receives an axial end of drive push rod 33 to provide a translatory path of movement of drive push rod 33 in the direction of drive shaft 41. A translatory actuator 42 is arranged opposite the straight axial end of drive push rod 33, shown ion FIG. 3, on the outside of injection moulding tool 14, which actuator may be designed, for example, as a motor that can be actuated electrically, pneumatically or hydraulically, in particular as a step motor. Actuator 42 is connected non-positively by a coupling 43 to drive push rod 33 so that drive push rod 33, in this case having a circular cross-section (FIG. 3), can be moved along drive shaft 41 in both directions.

Drive push rod 33 is mounted with its left part, shown in FIG. 1, in two guide holes 44, 45 of guide piece 31, so that a drive push rod 34, which is designed with an axial projection a (FIG. 2) in a guide recess 46, here having an almost cuboid shape, engages with its oblique toothing 47 in a corresponding oblique toothing 48 of drive push rod 33. The straight section of drive push rod 33, shown in FIG. 1, is mounted so that it sides in two guide holes 49, 50 of guide piece 32, between which holes a driven push rod 15 is received with axial projection a in each of two guide recesses 51 (FIG. 2). Driven push rods 35 are also provided with an oblique toothing 47 which engages with oblique toothing 48 of drive push rod 33.

Because of the tooth engagement between drive push rod 33, driven push rod 34 and driven pushrods 35, as well as the angle of obliquity α=45° of the oblique toothings 47, 8, chosen in this case, a translatory displacement of drive push rod 33 causes a corresponding translatory displacement of driven push rods 34, 35 in guide recesses 46 and 51 by means of actuator 42. In the embodiment shown in FIG. 1, a translatory movement of drive pushrod 33 to the left results in a translatory downward movement of driven push rods 34, 35 of the same magnitude along a driven shaft 59.

As FIG. 3 shows in the example of a driven push rod 35, a positioning device 52, designed in this case as a micrometer screw, is arranged in each of driven push rods 34, 35, which positioning device serves to receive a nozzle needle 53. The axial position of nozzle needle 53 relative to driven push rod 34 and 35 respectively can be reproducibly varied by means of positioning device 52.

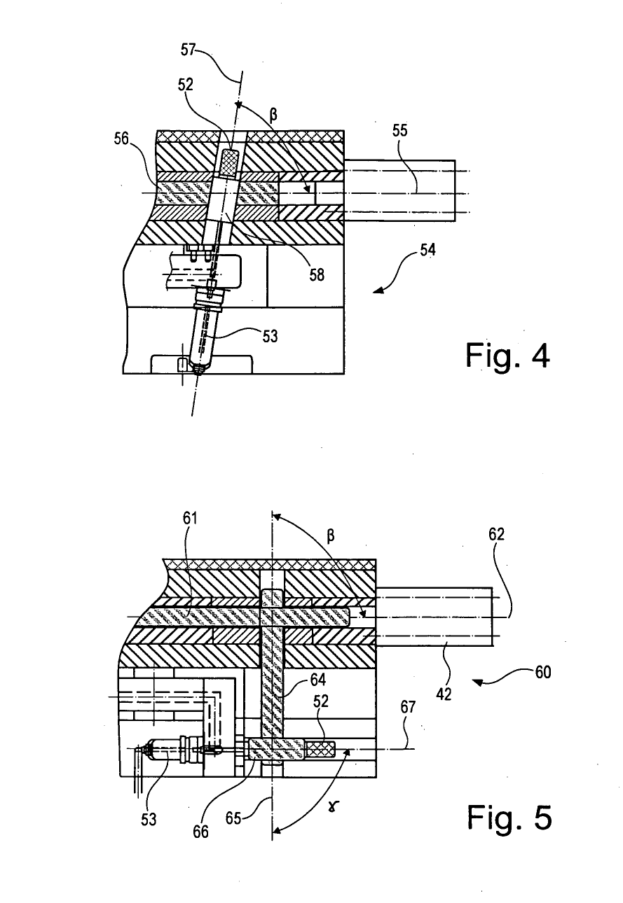

FIG. 4 shows, according to a further embodiment, a drive device 54 with a drive push rod 56, a driven push rod 58 and a nozzle needle 53 connected above a positioning device 52 to driven push rod 58. Here the angle of intersection β between a drive shaft 55 and a driven shaft 55, shown in FIG. 4, is approximately 60°.

As shown in FIG. 5 with reference to a further embodiment, it is also possible to provide a multiple axial deflection on a drive device 60. For this purpose drive device 60 has a drive push rod 61 which is translatorily displaceable along a drive shaft 62 by means of an actuator 42. Drive push rod 61 interacts with a first driven push rod 64, whose translatory displacement takes place along a first driven shaft 65, which is arranged at an angle of intersection β=90° to drive shaft 62. First driven push rod 64 interacts with a second driven push rod 65, which is connected to a nozzle needle 53 so that it can be translatorily displaced along a second driven shaft 67 by means of a positioning device 52. As FIG. 5 shows, the angle of intersection γ between first driven shaft 65 and second driven shaft 67 is also 90°, so that second driven shaft 67 is arranged parallel with driven shaft 62.

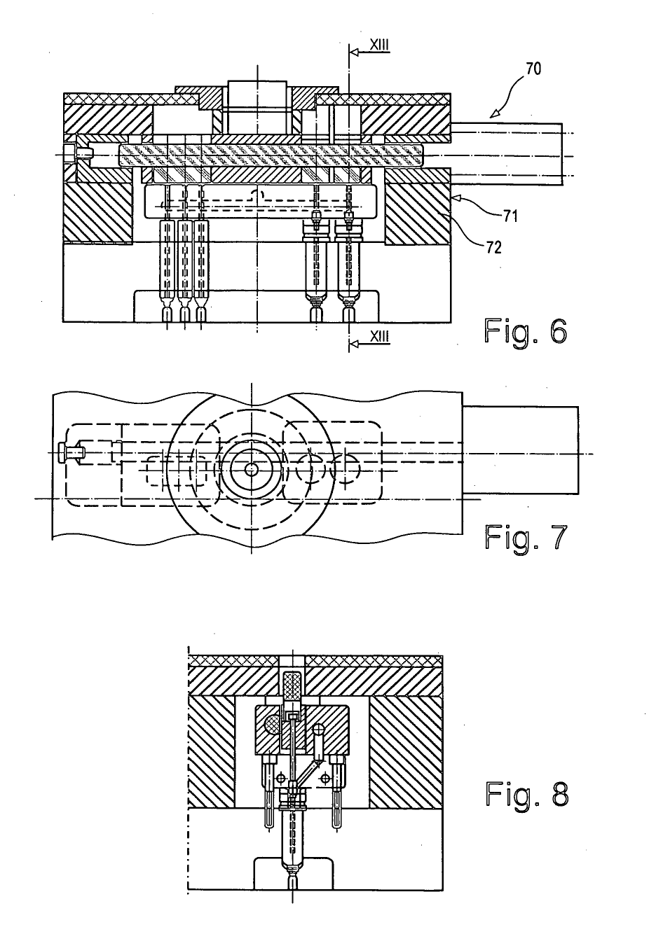

FIGS. 6 to 8 show a design in which a drive device 70 is designed as a constituent or added component of a hot runner distributor 71. As a comparison of FIGS. 1 and 6 shows, it is possible, because of the integration of drive device 70 in the housing of hot runner distributor 71, designed in the shape of a plate, to dispense with the separately illustrated lower cover plate 38 required in the embodiment of drive device 10 shown in FIG. 1, since this function is performed by distributor plate 72 of hot runner distributor 71.

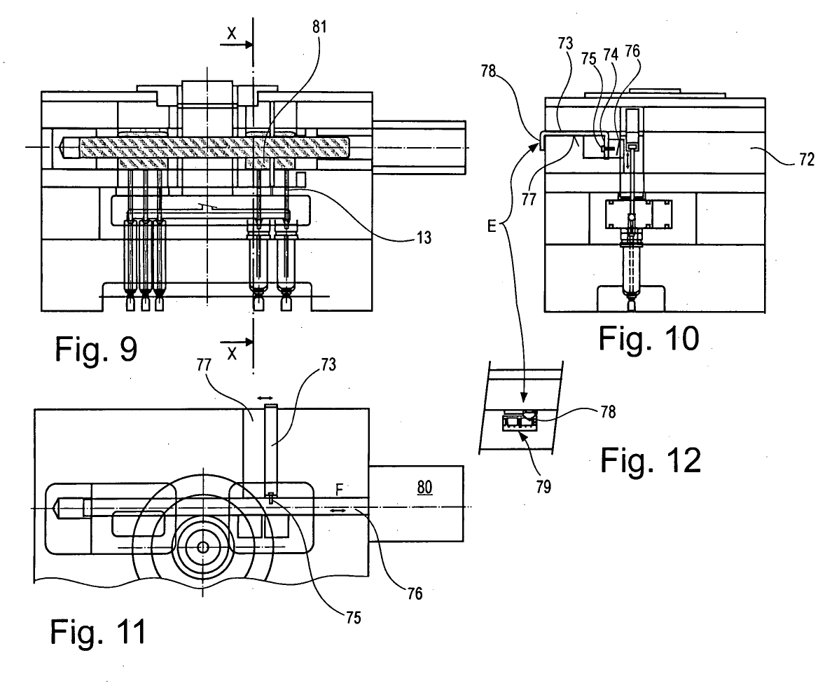

The embodiment shown in FIGS. 9 to 12 corresponds essentially, in its basic structure, to the embodiment shown in FIGS. 6 to 8. as shown in particularly in FIG. 10, an indicator 73 is provided which secured at its first end 74 by means of a screw 75 to drive push rod 76 indicated only diagrammatically. A slotted recess 77, open on the outside, is provided in distributor plate 72 (cf. also FIG. 11). Indicator 73 projects outwards with its second end 78 through the slotted recess, wherein end 78 is angled downwards. A scale 79, represented as detail E in FIG. 12, is provided on the outside of distributor plate 72.

If drive push rod 76 is now moved on the direction of arrow F by means of drive 80, the indicator is displaced by the same amount, wherein end 78 of indicator 73 overruns scale 79. By this means information is obtained simply and reliably on the position of drive push rod 76, and hence indirectly also on the position of further drive push rods 81 and hence of nozzle needle arrangement 13.

What is claimed:

1. A device for opening and closing injection nozzles in an injection moulding tool with a control gear for non-positive connection of a drive unit to a nozzle needle arrangement of one or more hot runner nozzles of the injection moulding tool, characterised in that the drive unit is arranged outside the injection moulding tool, and the control gear is designed a push rod gear with a first drive push rod for non-positive connection to the drive unit and at least one further driven push rod for non-positive connection to the nozzle needle arrangement, whose shafts intersect each other and have at least one pair of sliding surfaces, so that a parallax movement of the first push rod gives rise a parallax movement of the further push rod.

2. The device according to claim 1, characterised in that the push rods are designed as toothed racks.

3. The device according to claim 1, characterised in that the push rods are arranged in a guide element arrangement with guide recesses designed for sliding guidance of the push rods.

4. The device according to claim 3, characterised in that the guide element arrangement is designed in a modular housing unit for connection to the injection moulding tool.

5. The device according to claim 4, characterised in that the guide element arrangement is connected to the injection moulding tool with the intermediate arrangement of a hot runner distributor.

6. The device according to claim 1, characterised in that the guide element arrangement is designed as part of a hot runner distributor.

7. The device according to claim 1, characterised in that the nozzle needle arrangement is connected to the driven push rod by means of a positioning device.

8. The device according to claim 1, characterised in that the guide element arrangement has at least one guide piece which serves both to receive the drive push rod and to receive the drive push rod.

9. The device according to claim 1, characterised in that the guide element arrangement is provided in coaxial alignment with the drive push rod with the drive unit.

10. The device according to claim 1, characterised in that means are provided for indicating the position of the first drive push rod, the further drive push rod and/or the nozzle needle arrangement.

11. The device according to claim 10, characterised in that the means have an indicator which is connected essentially rigidly, in the region of its first end, to the first drive push rod, the further drive push rod and/or the nozzle needle arrangement, and interacts at its second end with a scale, which is provided in the region of the outer wall of the device, or is arranged inside the device, so that it can be read off through a recess in the outer wall of the device.

12. The device according to claim 10, characterised in that the means have a measured value transducer whose signal serves to activate an electrical or electronic indicating device.
